(19) United States
(12) Patent Application Publication
(10) Pub. No.: US 2017/0357479 A1
(43) Pub. Date: Dec. 14, 2017

(54) PERSONAL MUSIC CONTENT

(71) Applicant: Apple Inc., Cupertino, CA (US)

(72) Inventors: Arvind S. Shenoy, SanJose, CA (US); Alfredo Ramos-Alvarez, Middlesex (GB); Cody D. Jorgensen, SanJose, CA (US); Daniel Cartoon, South San Francisco, CA (US); Mark H. Levy, Winchester (GB); Matthias Mauch, London (DE); Paul C. Irvine, Cupertino, CA (US); Priyo Mustafi, Fremont, CA (US); Thomas Alsina, Saratoga, CA (US)

(21) Appl. No.: 15/273,428

(22) Filed: Sep. 22, 2016

Related U.S. Application Data
(60) Provisional application No. 62/348,969, filed on Jun. 12, 2016.

(51) Int. Cl. G06F 3/16; G06T 13/80; G06F 3/0482

(52) U.S. Cl. CPC G06F 3/167; G06F 3/0482; G06T 13/80; G06T 2200/24

(57) ABSTRACT

The present technology pertains to automatically providing refreshed versions of personalized playlists of media items based on a refresh schedule. The automatically refreshed personalized playlists can be automatically downloaded to a client device associated with the user account. In some embodiments an animation can be presented to show that a playlist was automatically refreshed. The automatically refreshed personalized playlist can be created based on an assumption that playlists are a collection of media items that go well together in a collection.

### RELATED APPLICATIONS

This application claims priority to U.S. Provisional Application No. 62/348,969 filed on Jun. 12, 2016, entitled “Personal Music Content”, which is incorporated herein by reference.

### TECHNICAL FIELD

The present technology pertains to media item playlists and more specifically pertains to providing automatically refreshed, highly-personalized media item playlists.

### BACKGROUND

Media item subscription services and a shift in media item consumption from album centric consumption to single media item centric consumption have made it more challenging for media playback services to automatically generate high quality media item playlists. While it used to be enough to create playlists predominantly based around favorite artists or albums, today's users tend to have a much more diverse listening interest due to the fact that today's users have access though subscription services to a much larger universe of music. While yesterday's users might find their listening interests strongly correlated to specific genres, such correlation is very much diminished for today's users.

This creates a complex technical problem. Instead of generating playlists centered on specific genres, artists, and albums, a playlist that users might listen to might span many different genres, artists, and albums, i.e., a good playlist today might be far more diverse. It is now more complex than ever to identify a user's listening interests. And since today's listening users generally have more diverse tastes than earlier generations, determining what media items go well in a playlist together is also more complex.

Additionally, algorithmically created playlists are also sometime inadequate with respect to their selection of media items to place together in a playlist. Even when media item candidates that match the user's listening interests are identified, algorithms often do a poor job of selecting media items on the basis that they go well together in a playlist, or that are sequenced well in a playlist. Determining a good sequence of media items is also a challenging technical problem.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for automatically providing refreshed versions of personalized playlists of media items. In some embodiments one or more playlists can be assigned to a refresh schedule and a media playback service can automatically generate a refreshed playlist according to the refresh schedule. The playlist can be created according to one or more rules that defines the playlist. Some examples of such playlists and their rules include a music discovery playlist that includes media items that match a taste profile for a user of an account of the media playback service that the user has not previously played (or has not played within some defined period). Another example playlist could be a favorites playlist that includes media items that have been marked as favorites by a user of the account of the media playback service. Another example playlist could be new releases playlist that includes media items that match a taste profile for a user of the account of the media playback service that have been released recently. Another playlist could be daily mix that could include any media items that match a taste profile for a user of the account of the media playback service along with other flexible criteria that could be randomly chosen, or selected by an algorithm.

The automatically refreshed personalized playlists can be automatically downloaded to a client device associated with the user account. In some embodiments an animation can be presented to show that a playlist was automatically refreshed. In some embodiments the media items from the playlist are also automatically downloaded by the client device.

The automatically refreshed personalized playlist can be created based on an assumption that playlists are a collection of media items that go well together in a collection. What media items go well together is mostly if not entirely subjective. Media items might go well together because they fit a theme (i.e., the media items are up-tempo if the playlist is a workout mix, or the media items are love songs in a love song mix, or the media items are a selection of favorites that a user wants to listen to together). The fact that two media items are considered similar does not necessarily mean they go well together in a playlist. Likewise, the fact that two media items are not considered similar (such as from different genres, or based on other criteria) does not necessarily mean they do not go well together in a playlist. This is especially true when taking into account a taste profile associated with an account of the media playback service. Accordingly, the automatically refreshed personalized playlist disclosed herein can be created based on a dataset of media items that have been included in user selected sequences of media items in the past, which indicates that users have found those media items to go well together in a playlist. Media items are included into an embedding space based on this criteria (that media items have been observed to occur together in playlists). A user's taste profile can be used to locate media items or clusters of media items in the embedding space. In some embodiments both the embedding space and the user's taste profile are subject to analysis by deep learning algorithms. Media item candidates for a playlist can be selected according to criteria or rules associated with the playlist. The candidates can be selected and sequenced in the playlist by a sequencing algorithm according to a sequencing model.

The method of creating playlists is not limited to creating the automatically refreshed personalized playlists disclosed herein. User defined criteria can be utilized to create playlist on demand using the organization of media items provided by the embedding space, the user taste profile, sequencing algorithm and other features disclosed herein.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 illustrates an example system diagram;

FIG. 2 illustrates an example method for creating an embedding space;

FIG. 3 illustrates an example method for mapping a user taste profile to the embedding space;

FIG. 5 illustrates an example method for identifying playlist candidates from the embedding space and sequencing candidates in a playlist;

FIG. 6 illustrates an example method of requesting a refreshed playlist and delivering a refreshed playlist to a client device;

FIG. 7A illustrates an example representation of a refreshed playlist;

FIG. 7B and FIG. 7C illustrate an example animation of introducing a current refreshed playlist;

FIG. 7D illustrates example personalized playlists in an example page of personalize media recommendations; and

FIG. 8 illustrates and example computing system architecture.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for algorithmically creating, automatically refreshing, highly personalized playlists of media items. An important attribute of a good playlist is that the media items go well together in the playlist. It is not enough that the media items are merely in similar genres or by similar artists or considered similar according to some high level attribute. Accordingly, the present technology identifies media items that go well together in a playlist, and from these media items determines media items that match the taste preference of a particular user. After candidates for inclusion in a playlist of media items are identified, candidates are evaluated and selected for inclusion in a playlist based on how well they fit in a sequence with other candidates.

One aspect of the present technology is the gathering and use of data available from various sources to improve creation of playlists for a user. The present disclosure contemplates that in some instances, this gathered data may include personal information data that uniquely identifies a specific person, and/or includes data about a user's personal preferences. The present disclosure recognizes that the use of such personal information data, in the present technology, can be used to the benefit of users.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

As used herein, the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

As used herein, the term “user” shall be considered to mean a user of an electronic device(s), and/or a user associated with an account of media playback service 102. Actions performed by a user in the context of computer software shall be considered to be actions taken by a user to provide an input to the electronic device(s) to cause the electronic device to perform the steps embodied in computer software. In some instances, a user can refer to a user account associated with a particular electronic device.

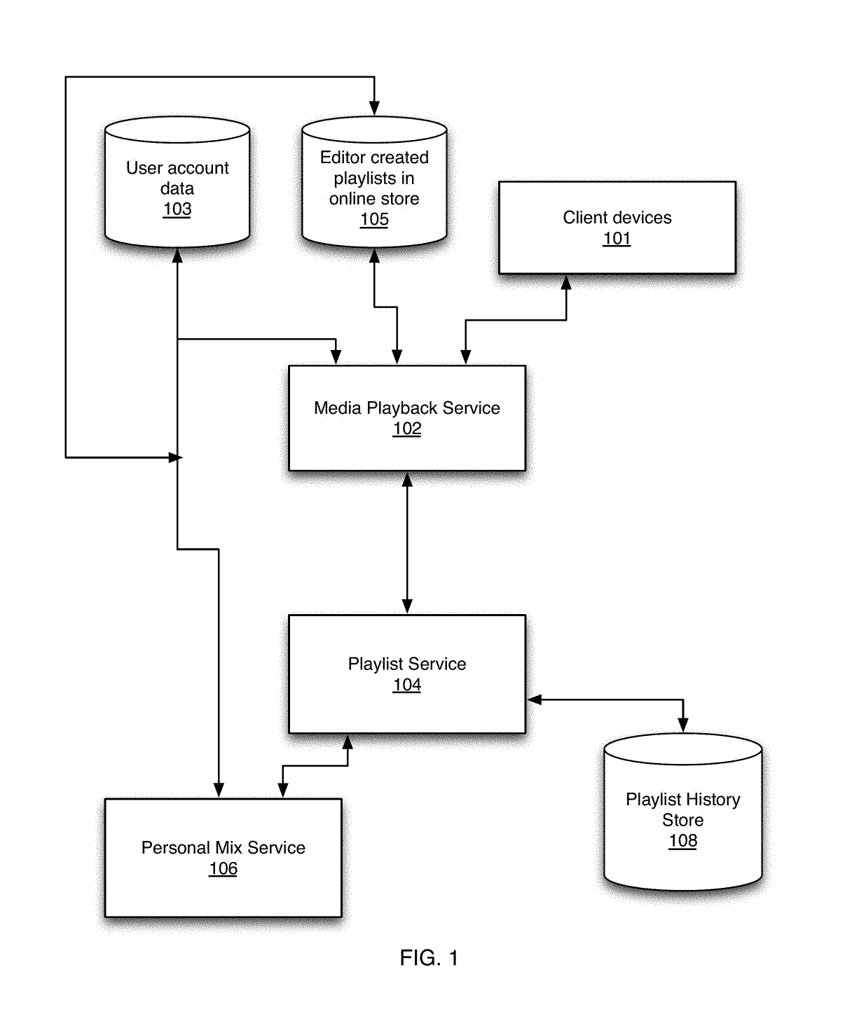

FIG. 1 illustrates an example system diagram. The system illustrated in FIG. 1 can be used to create and deliver refreshed, personalized playlists. Client device(s) 101 are computing devices used to access media playback service 102. Media playback service 102 is a service that provides media items to client devices so that media items can be played by the client devices. In one embodiment, editors associated with media playback service 102 can curate playlists 105 or recommendations of media items to be played by client devices 101. Media playback service 102 can have accounts associated therewith, to which client devices 101 can use to login to the media playback service. Each account is associated with user account data 103 that includes profile information, purchase information, and a history of played media items.

Media playback service 102 can make use of a playlist service 104 to algorithmically create personalized playlists for delivery to client devices 101. In some embodiments, these playlists can be periodically refreshed. A record of each playlist created/delivered by the playlist service 104 can be recorded at playlist history store 108. Personal mix service 106 can perform offline processing and machine learning of relationships between media items available through the media playback service 102. This processing and machine learning can be used by playlist service 104 to create playlists.

When a person creates a playlist, they have chosen a selection of media items that the person wants to hear together. Implicit in the creation of playlist is that its creator believes that the selections go well together as a group. Often, the creator of a playlist has also sequenced the media items so that the media items go well together in the specific order that they are listed (e.g., songs transition well, general progression of tempo throughout the playlist, etc.).

Therefore, in order to create a good algorithmically created playlist, media items must be chosen because they go well together and specifically because they go well together in a playlist. The first step in creating a good algorithmically created playlist is to identify media items that go well together in sequence.

Media playback service 102 has access to a large number of playlists, and thus can learn which media items go well together in sequences. Specifically, media playback service has access to user account data 103 including user-created playlists associated with accounts of the media playback service, and on demand playback histories associated with accounts of the media playback service. Media playback service 102 also has access to playlists available in an online store, including editor created playlists 105. Each of the user-created playlists, the on demand playback histories (user selection of media items to playback on demand), and the editor created playlists all represent sequences of media items where a user has selected the media items and the order of their playback, and therefore are potential datasets from which it can be learned which media items go well together in sequences.

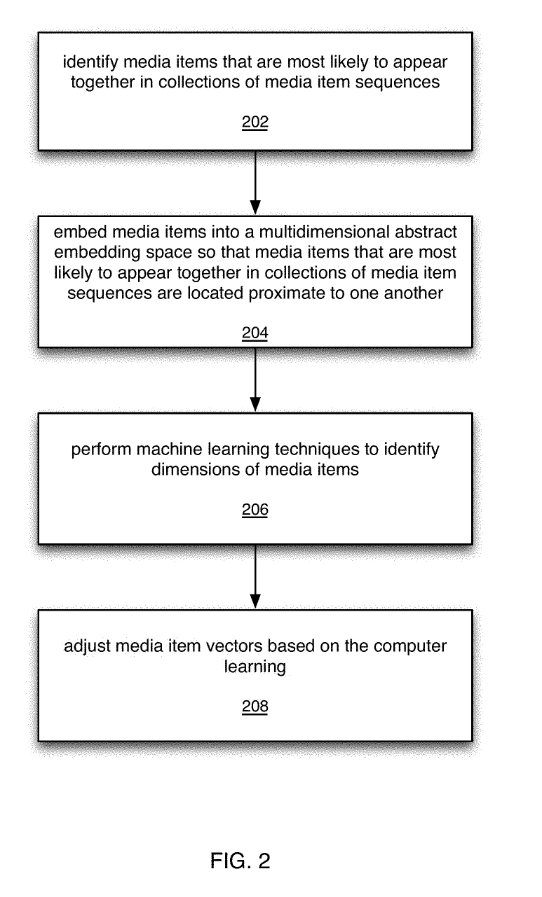

FIG. 2 illustrates an example method of identifying which media items go well together in sequence through embedding media items that most often appear together in user-created media item sequences proximate to each other in an abstract, multi-dimensional embedding space. An embedding space is an abstract space in which media items can be inserted and located in the space based on criteria (such as how likely two media items are to occur together in a playlist). The more often two media items are observed together in a sequence, the closer together the two items can be arranged in the embedding space.

A personal mix service 106 can analyze media item sequences in collections 103, 105 to identify 202 media items that are most likely to appear together in collections of media item sequences. While collection 103 includes media item sequences that are specific to specific accounts, the identification 202 of media items that are most likely to appear together in collections of media item sequences is across the many media item sequences irrespective of the specific account to which the media item sequence is associated. In order to qualify as a dataset that could be analyzed in step 202, the dataset need only be a media item sequence grouped together in a user created list such as those stored in collection 103 (user created collections), and collection 105 (editor created collections).

The more often two media items are identified 202 in the collections of media item sequences, the more likely the two media items are to appear together in the same sequence or playlist. Based on the identification 202 of media items that are most likely to appear together in a media item sequence, the media items are embedded 204 into a multidimensional abstract embedding space so that media items that are most likely to appear together in a collection of media items are located most proximate to one another. In other words, media items are treated as a point in the multidimensional abstract embedding space and they are placed into the embedding space so that they are located proximate to points representing other media items that often appear in collections of user created media item sequences.

In some embodiments clustering algorithms known to those of ordinary skill in the art can be utilized to arrange the media items in the embedding space. In some embodiments, the embedding 204 may need to be iteratively performed before an optimal embedding is observed.

Steps 202 and 204 are effective to identify media items that have been observed to belong together in user created media item sequences, but additional analysis may need be performed to understand why the media items belong together in user created playlists. In some implementations it may be useful to attempt to understand what dimensions of the media items themselves make it so that they are selected by users to belong together in user created media item sequences.

In some embodiments, to attempt to learn dimensions of the media items that make it so that the media items located proximate to each other in the embedding space are selected by users to belong together in user created media item sequences, the personal mix service can perform machine learning techniques 206 to analyze the media items in the embedding space to identify dimensions of media items. In some cases, the identified dimensions may correspond to an easily human comprehensible attribute of the media items such as sub-genre, or some musical attribute including prominent instruments, etc., but such correspondence would be merely coincidental. The machine learning techniques are not limited to determining human comprehensible attributes, and instead the machine learning techniques will likely learn less human-definable dimensions. In some embodiments, the machine learning techniques used are classified as deep learning techniques.

Based on the output of the machine learning 206, vectors that are representations of the media item as defined by its dimensions can be created or adjusted 208. With continued analysis the vectors of media items that are most proximate to each other in the embedding space should become similar.

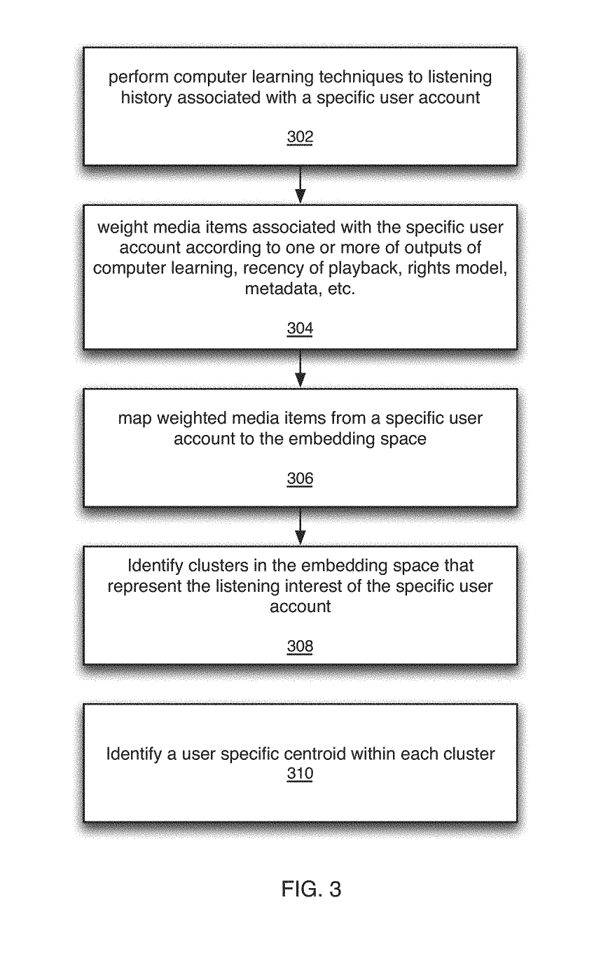

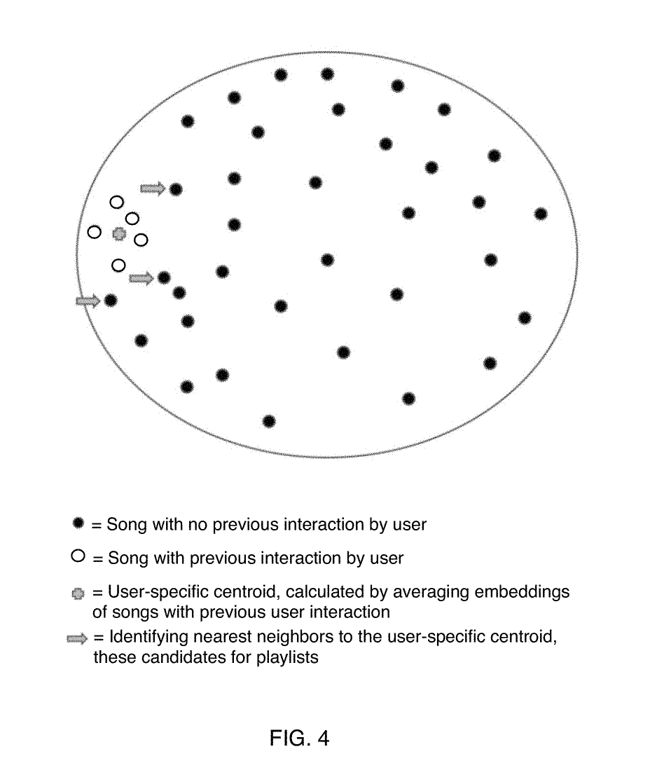

Merely identifying media items that have been observed to go well together in user created media item sequences isn't enough to identify candidates for a playlist that a user of a specific account would enjoy as each user has a unique taste profile. Each user's taste profile needs to be mapped to the embedding space so that playlists that specific user's would enjoy can be created. FIG. 3 illustrates an example method of mapping a user's taste profile to the embedding space.

In its simplest form a user's taste profile can be mapped to the embedding space simply by identifying media items that the user has listened to in the embedding space, and identifying concentrations of those media items. However, using more advanced techniques it may be possible to better identify a user's taste profile, which can be complex. Specifically, user's taste in media can change rapidly and can be different depending on time of day, location of playback, or other factors that are harder to conceptualize. FIG. 3 illustrates an example method that attempts to account for the complexities of a user's taste profile. However, it should be appreciated that one or more steps can be excluded or added.

Personal mix service 106 can access user account data 103 to retrieve a playback history associated with a specific account of the playback service 102. Personal mix service 106 can perform 302 machine learning techniques to user account data 103. The specific leanings from the machine learning techniques can include some more conceptualizable characteristics such as low level musical characteristics of media items that the user listens to, how time of day or environment affects what a user might listen to, how popularity of a media item affects playback, etc. However, the leanings from the machine learning techniques might be less conceptualizable too.

Personal mix service 106 can weight 304 media items from user account data 103 according to one or more of outputs of machine learning, recency of playback, rights model, metadata, etc. For example, the machine learning process can determine that particular media items from user account data 103 are closely aligned to the user's current music interest and can weight these items heavily. Additionally, media items that have been played back more recently are more likely to represent the user's current music interest and so they can be weighted more heavily than media items listen to two months ago. Additionally, a media item was added to the user's media library can be weighted more heavily than a media item that was merely streamed. Likewise, a media item that was purchased when the same media item was available through a subscription model could be weighted even more heavily. Similarly, a media item that is accompanied by metadata that indicates a user's interest—such as a ranking, or a like or heart, can also be used to weight an item more heavily. Additional factors are also possible. Factors can be used in isolation or in combination to yield weighted media items.

Personal mix service 106 can map 306 the weighted media items from a specific account to the embedding space, and identify 308 clusters in the embedding space that best represent the listening interest of the specific account. The clusters that most represent the user's listening interest can include clusters that have the greatest number of media items within them, or can include clusters that include the highest weighted media items within them. Personal mix service 106 will typically identify multiple clusters as most users' taste profiles are somewhat diverse.

Within the clusters identified 308 that best represent the listening interest of the specific user account, there can be many thousands of media items. Since the cluster was created in an embedding space based on the fact that media items go together well in a playlist and this was based on a population of accounts, it can be that the listening interest of the user account is actually reflected by only a subset of the cluster. Thus to better hone in on a user's taste profile, personal mix service can identify 310 a user specific centroid within each cluster.

FIG. 4 illustrates an example cluster that represents 308 the listening interest of the user account, and identifying 310 a user specific centroid within the cluster. As illustrated in FIG. 4, the cluster contains many media items that the user account has never had any interaction with (e.g., never played back), but does include a concentration of media items in which the user account has previously interacted with (e.g., has played back). FIG. 4 also illustrates a user specific centroid, which is a weighted average of the placement of the media items that the user account has interacted with in the embedding space. The weight given to individual media items can be provided by any suitable function, but in some embodiments, a function will weight media items played more recently a little higher than media items played further in the past. In some embodiments, the centroid need not be an average and instead a given media item that appears to reflect the user's specific listening interest can be used in place of a centroid.

As will be appreciated by those of ordinary skill in the art, the method illustrated in FIG. 3 will likely identify different clusters for the same user as the method is periodically repeated over a period of time since a user's listening interest changes with time and the weighting factors can be selected to represent a user's current music interest.

As noted above, a user's taste profile can also vary during a day depending on factors such as time of day, mood, activity, weather, or other factors. The machine learning techniques can identify such factors. When such factors are identified, it can be appreciated that the weighting 304 of media items could vary depending on these factors. In some embodiments, the method of FIG. 3 can be performed with different weightings to account for commonly observed factors.

One such factor that could be especially important is the device that is used for playback. Some accounts, while registered to only one user, are actually used on several media playback devices that might be operated by multiple people other than an account holder. This is especially common in families where a parent might allow their children to use a tablet or portable media playing device occasionally. If such a pattern were identified, personal mix service 106, would weight media items according to the device used for playback so that the listening interest of the user that most commonly operates a specific device is not confused with other people in their family.

In some embodiments, the methods illustrated in FIG. 2 and FIG. 3 are performed in an offline process, i.e., a process performed at a scheduled time as opposed to at the request of the playlist service 104.

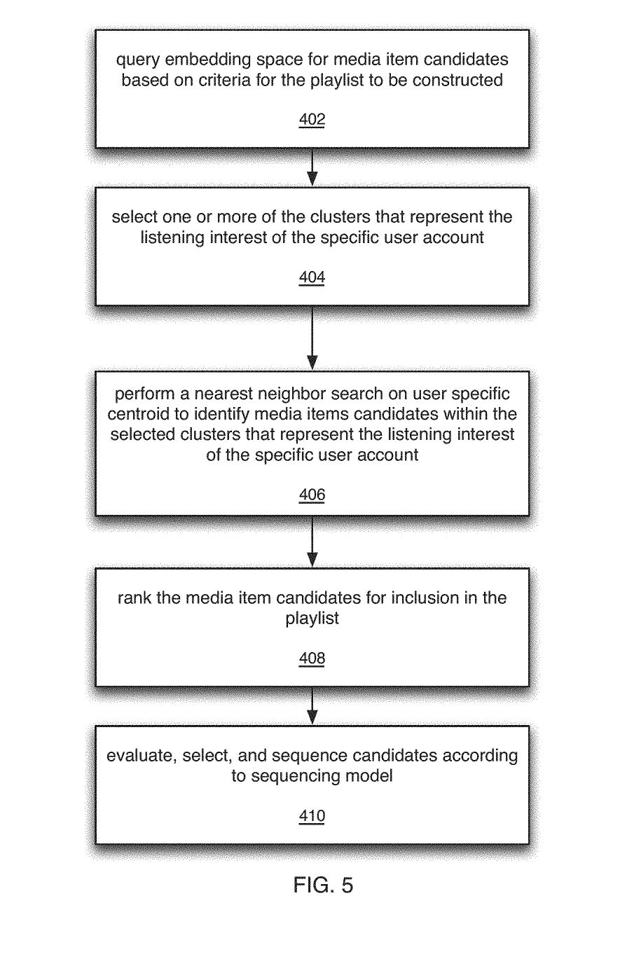

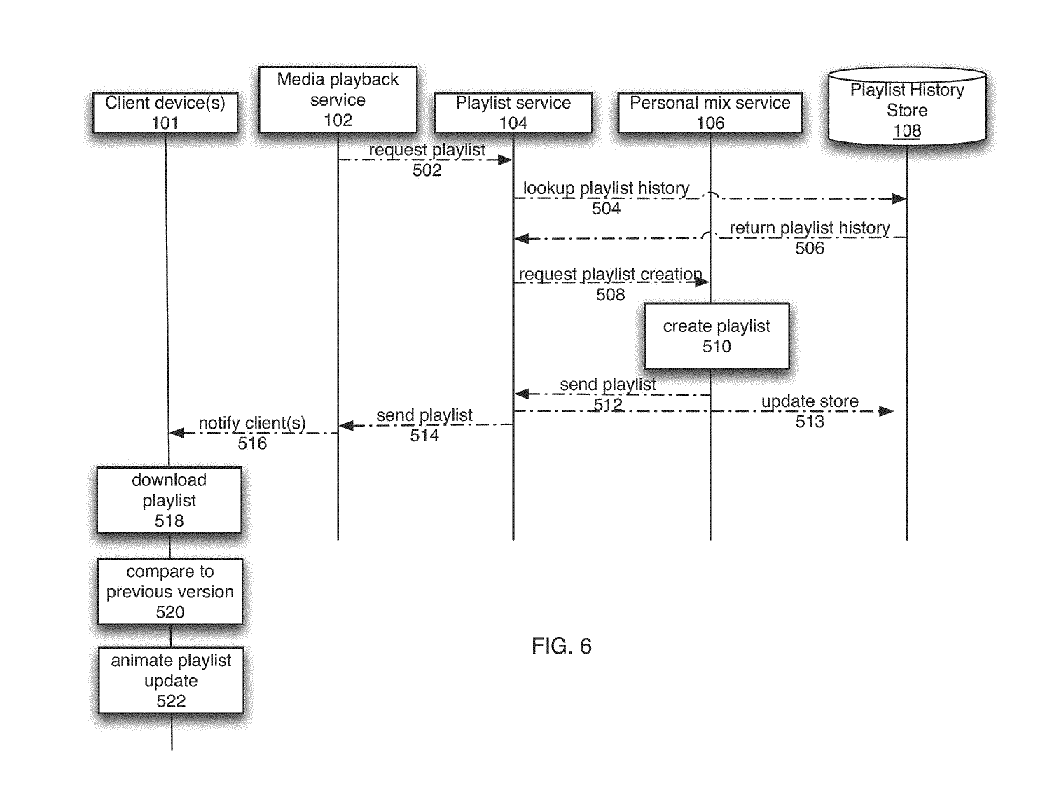

FIG. 5 and FIG. 6 illustrate example methods used in creating a playlist. FIG. 5 illustrates an example method of selecting candidate media items for inclusion in a playlist.

Playlist service 104 can query 402 personal mix service 106 for media item candidates that match criteria for the playlist to be constructed. Such criteria can include a genre, theme, device, time of day, etc.

In some embodiments, personal mix service 106 can select 404 one or more of the clusters that represent the listening interest of the specific account, and that best respond to the query.

To identify 406 media items, personal mix service 106 can perform a nearest neighbor search based on the user specific centroid within clusters that contain media items that match criteria for the playlist to be constructed. Since media items are identified 406 from clusters that include media items that the specific account has experienced, and the centroid used as the starting point for the search is user specific, the candidates identified 406 will likely represent the listening interest of the specific account. In some embodiments, the search criteria is relevant to the other attributes of media items other than a cluster that contains them. For example, if the search criteria is only for new music, media items released (or published to media playback service 102) before a particular date can be excluded. In another example, if the search criteria is for media items the account hasn't played before, only media items that don't appear in the user account listening history 103 are identified 406. In some embodiments, comparing the media items to the search criteria is part of step 408.

FIG. 4 illustrates identification 406 of candidate media items within a cluster. FIG. 4 illustrates a user specific centroid and illustrates candidate media items within the cluster because they are nearest to the user specific centroid. In some embodiments, the distance from the user specific centroid in which a candidate can be can be configurable. If a goal of a playlist is to expose a listener to media items that slightly diverge from the taste profile of the user account, candidates can be selected from a greater distance from the user specific centroid.

Once media item candidates are identified 406, personal mix service 106 can rank 408 the media item candidates for their desirability to include in the playlist. In addition to determining how well a media item candidate matches the search criteria, other factors can be used in the ranking. For example, any leanings from the machine learning performed 302 on the user account data 103, can be applied in this ranking process as well. Additionally, in some embodiments, media items recommended by editors can influence the weighting. As will be appreciated by those of ordinary skill in the art, any number of factors could influence the weighting of candidates.

Merely identifying good, personalized candidates for inclusion in a playlist is not the only key to creating a quality, personalized playlist. The sequence that candidates are arranged in matters too. The media items having a rank 408 high enough to be included in the playlist can be evaluated, selected, and sequenced 410 according to a sequencing model. One such sequencing model is described in U.S. application Ser. No. 14/684,063, filed on Apr. 10, 2015 and titled “Content Item Recommendations Based On Content Attribute Sequence”, and is incorporated by reference herein in its entirety.

The sequencing model can be created from using machine learning techniques to analyze user created sequences of media items to learn one or more models for a flow of a playlist. An over simplified example of learned sequence model might be that a good playlist begins with an up tempo selection of media items, followed by a slower tempo media item, and then followed by up tempo media item again. A playlist can be considered to have positions. A first position is for the first media item, a second position for the second media item, a third position for the third media item in the playlist and so on. The personal mix service 106 can evaluate 410 potential sequences of the highly ranked 408 media items to be placed in each position according to the one or more sequence models to create a good sequence. In some embodiments, the personal mix service can iteratively evaluate a plurality of possible sequences before selecting candidates for each position in the playlist. A good sequence might not include the best individual candidates for each position, but instead focuses on a sequence of media items that goes well together and that is arranged as best as possible according to one or more language models.

The output of FIG. 5 is a playlist of media items that contains media items that match query criteria, that contains only media items that go well together in a sequence, that contains only media items that match a specific user's listening interest, and that are arranged into a playlist in a sequence that is preferred based on the output of machine leanings from analysis of user created playlists.

In some embodiments, there can be more than one embedding space. The embedding space described above with respect to FIG. 2 is used to embed media items that are most likely to appear together in collections of media item sequences proximate to one another. Other embedding spaces can also be used. One such embedding space is one that maps media items according to similar musical attributes. Deep learning techniques can be performed on the media items available through the media playback service 102 to determine media items that have similar acoustic attributes and personal mix service 106 could map media items into another abstract embedding space based on similarity of musical attributes. The musical similarity embedding space can then be mapped onto the embedding space of media items that belong together in user created sequences of media items. Machine learning can then be applied to adjust the media item vectors as described with respect to step 208.

Using multiple embedding spaces can be a valuable way to learn about other relationships of media items that could be helpful in creating a better playlist. In the example of an embedding space based on musical attributes, this could provide significant benefit with respect to new media items. New media items will only appear in editor created playlists, which is a small number of total playlists across a population. Also editors, while skilled at identifying new media items of interest, still have an inherent bias in their selections so new media items might not be placed into the best place in the embedding space of media items that belong together in user created sequences of media items, but would be better characterized by a media items inherent qualities in an embedding space based on similarity of musical attributes.

The methods described in FIGS. 2-4 can be used to keep music on a client device 101 that has been refreshed so that music stored on the client device 101 does not become boring or overplayed. Client devices 101 can include a laptop, mobile phone, tablet, dedicated media playing device, etc. that is associated with an account of the media playback service 102. Media playback service 102 can be any service that can playback media items, or transmit or stream media items to client devices 101 so that the media items can be played by the client devices 101. In some embodiments, media playback service 102 provides a collection of media items that conform to an account's listening interest (presumably a user controls the account, and thus the account's listening interest is really the listening interest of the account holder (or a user of a device), but since the listening interest is determined by account activity, this specification refers to account listening interest). For example, media playback service 102 might have a “For You” page on a website accessible by a client device 101 that is logged into the media playback service, or in an app stored locally on the client device. In some embodiments, the “For You” page can include one or more playlists that refresh periodically that conform to the account's listening interest.

FIG. 6 illustrates an example method for keeping a fresh playlist on a client device. In some embodiments, media playback service 102 can keep track of a schedule for refreshing playlists for an account. For example, media playback service provides a “discovery” playlist that includes media items, that according to user account data 103, have not been played back within a determined period of time. Media playback service 102 might refresh this playlist every Tuesday at 10 am. When media playback service determines it is time to provide a refreshed playlist for the account, media playback service 102 requests 502 the refreshed playlist from playlist service 104. The request can identify the account for which the playlist is being requested, the playlist name, and/or parameters for playlist creation. In some embodiments, each refreshed playlist is identified by an ID which is specific to the account and the playlist parameters. In some embodiments, the playlist name is the only parameter that is needed. For example, “Discovery Playlist” implies the parameters for the discovery playlist. A discovery playlist will be known to have parameters that require that media item candidates for the playlist should mainly be media items that have not been playbacked by the account before, or at least not within a determined period. A top songs playlist will be known by the playlist service 104 that candidates should be media items that have been highly rated by a user of the account.

In some embodiments the client device can request an updated or refreshed playlist.

In response to the request 502, playlist service 104 uses the information in the request 502 to lookup 504 playlist history for the identified playlist in the playlist history store 108. Playlist history store includes a record of all playlists created for playlist service 104 and includes information such as media item identifiers of media items in the playlists, and date of creation for the playlists. The playlist history store 108 can be especially important for refreshing a “Discovery Playlist” where the purpose is to introduce an account to media items that it has not played before. The playlist history store 108 can also be useful in embodiments wherein it is desired to maintain some continuity between refreshed playlists so that a playlist evolves over time instead of completely refreshing each time a new playlist is requested and created. The playlist history store 108 can also include other information pertinent to the creation of past playlists such as any machine learning information relevant to an account's specific tastes. Playlist history store 108 can return 506 this information to the playlist service 104, which can pass pertinent information to the personal mix service 106 when requesting 508 playlist creation. In some embodiments, playlist history store 108 can also be in communication with the personal mix service 106.

In response to request 508, personal mix service 106 can perform relevant steps of the method illustrated in FIG. 5 to create the playlist 510. After the playlist has been created, personal mix service 106 can send 512 the playlist to the playlist service 104, which can update 513 the playlist history store 108 and send the playlist 514 to media playback service 102. The media playback service 102 can send a push notification 516 to client device(s) 101 associated with the account for which the playlist was created. In some embodiments, the playlist service 104 can notify the client(s) 101. In some embodiments, the notification 516 need not happen, and a client device 101 could learn of the created playlist only upon request for updated playlists by the client device 101.

In some embodiments, playlists might get created by playlist service 104 and personal mix service 106, but are never downloaded to a client device. In such embodiments, playlist history store 108 can record that the playlist was never played. And since those media items were never experienced by the account, these media items could be maintained as candidates for future “Discovery Playlists.”

When a client device 101 is ready, it can download 518 the playlist. In some embodiments, the playlist can passively download in the background according to user preferences so that the playlist and media items are cached on the client device and ready for whenever an account holder (or user of a device associated with the account) is ready for playback of the playlist. In some embodiments, the playlist and media items are only downloaded on demand.

After downloading 518 the playlist, the client device 101 compares the playlist to the previous version 520 to determine differences from a previous downloaded version of the playlist to the current version. In some embodiments, the parameters of the playlist might be such that there can be no overlap in media items from a past version to a current version. In such embodiments the compare might be skipped.

The comparison 520 can be utilized in an animation 522 visually informing the account holder (or user of a device associated with the account) that the playlist has been refreshed. If an item is in common between a previous version of the playlist and a current version of the playlist, the animation 522 can keep the media item in place, change its position, or remove the media item from the graphic representing the playlist.

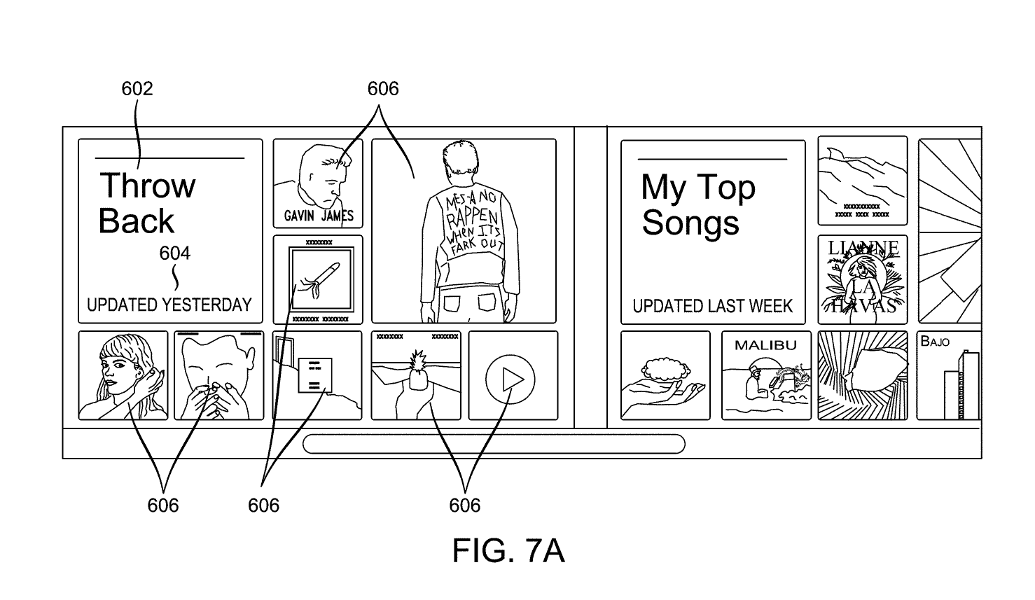

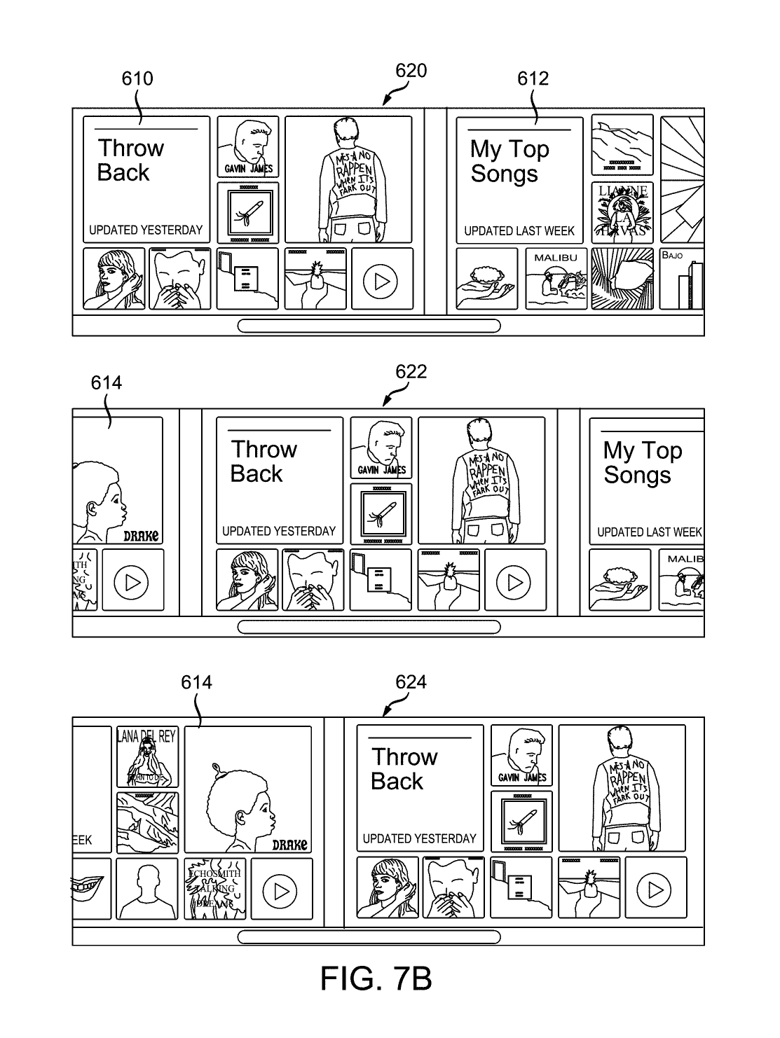

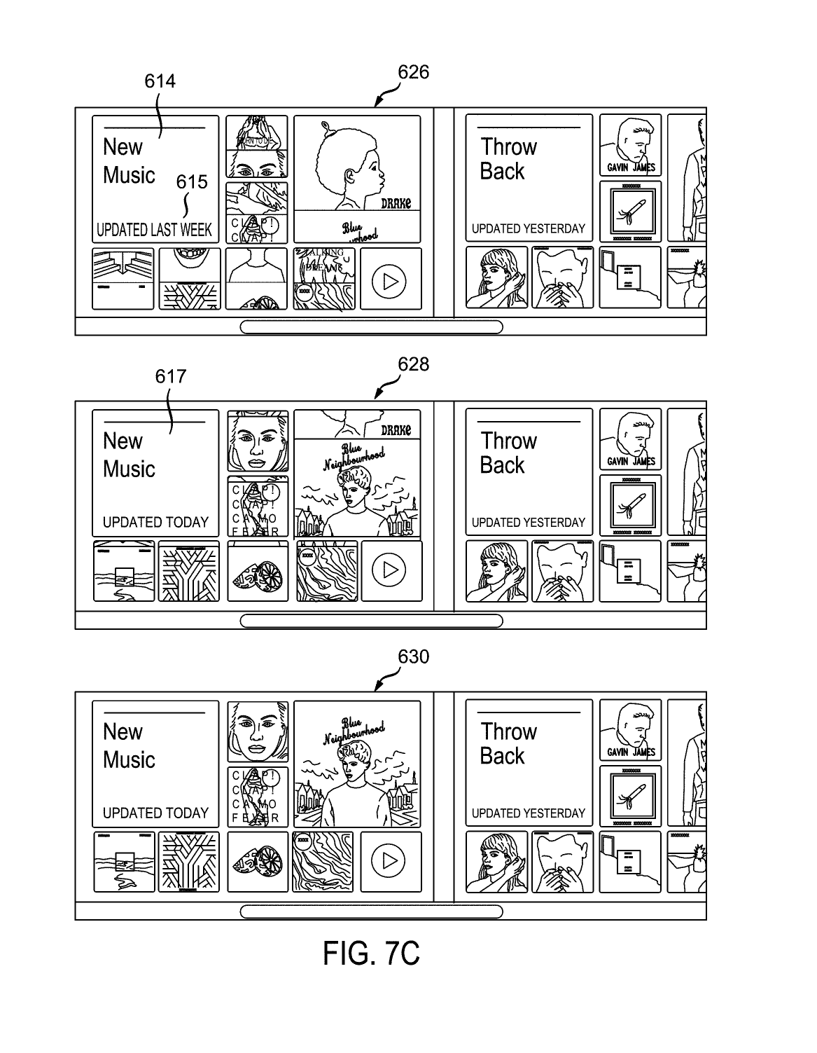

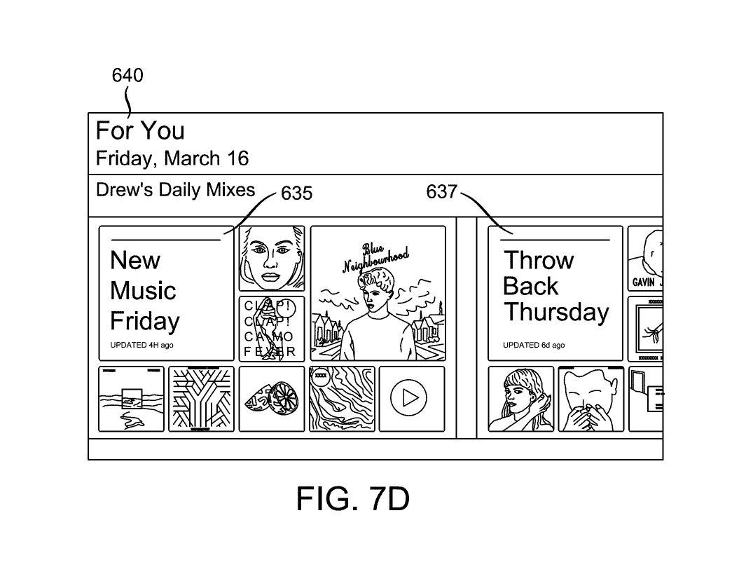

FIG. 7A illustrates an example representation of a playlist. The playlist has a title 602 called “Throw Backs”, and refresh indicator 604 indicating the last time the playlist was updated. Additionally, the representation includes thumbnail images of media items 606 of a portion of the media items included in the playlist.

FIGS. 7B and 7C illustrate an example animation visually informing the account holder (or user of a device associated with the account) that the playlist has been refreshed. FIGS. 7B and 7C illustrate a series of frames 620, 622, 624, 626, 628, 630 that progress through the example animation. In frame 620 playlists 610 and 612 are visible. Playlist 610 is on the left and is the most recently refreshed playlist (refreshed yesterday) and playlist 612 was refreshed earlier (last week).

When a new playlist is available, playlists 610 and 612 animate and slide to the right to make room for the newly refreshed playlist 614 shown entering the screen in frame 622, and sliding further into view in frame 624, and finally fully into view in frame 626. Playlist 612 is no longer visible, but can be accessed by scrolling to the right.

As playlist 614 comes into view in frames 622, 624, and 626 it still displays thumbnail artwork of media items in the previous version of the playlist. In frame 626, the playlist still shows that it was updated last week 615. However, as the playlist comes fully into view the thumbnails animate to become replaced by tracks in the refreshed playlist and the refresh indicator in frame 626 updates from “updated last week” 615 to “updated today” 617 in frames 628 and 630.

In the example embodiment illustrated in frames 626, 628, and 630, the new thumbnail artwork slides up from the bottom to replace the old album artwork. However, many animation techniques are known in the art and the present technology isn't limitation to any specific animation technique.

In some embodiments, a client device 101 might not have downloaded the previous refreshed playlist (e.g., a playlist is created every Monday, but the device hasn't been connected to the media playback service 102 for the last month, and so the client device does not have the previous refreshed playlist, or the current one). In such embodiments, the client device 101 can receive multiple versions of the refreshed personalized playlist to backfill at least a portion of the missing playlists. This can happen when the refreshed personalized playlists are made available periodically, and the requesting client device has been offline for at least one complete period, one of the received multiple versions of the refreshed playlist backfills a user interface showing a past refreshed personalized playlist, and one of the received multiple versions of the refreshed playlist is the refreshed playlist for the current period.

For example, referring back to FIG. 7B, the graphical user interface can be navigated by scrolling to the right to view progressively older playlists. Playlist 612 was updated last week, playlist 610 was updated yesterday, and playlist 614, which is being updated today in this animation. By scrolling to the right, it may be possible to view all playlists created within a period. However, if the device has not been online during that period, the client device 101 will need to download all of the missing playlists from the media playback service 102. In some embodiments, this could also include the previous version of the playlist being refreshed.

FIG. 7D illustrates personalized playlists 635 “new music Friday” and 637 “Throw Back Thursday” on a page 640 of personalized media item recommendations—called “For You.”

In some embodiments, the client device 101 can also automatically download all of the media items in the refreshed playlists so that the playlists are available even when the client device 101 is offline. In some embodiments, the client device will need to download data identifying the refreshed personalized playlist and the media items included in the refreshed personalized playlist. From the downloaded data, the client device can determine which of the media items included in the refreshed personalized playlist are already on the computing device, and download and cache the media items in the refreshed personalized playlist on the client device 101 that are not already on the client device 101.

In some embodiments, client device 101 can utilize the downloaded data identifying the refreshed personalized playlist and the media items included in the refreshed personalized playlist to compare a current refreshed version of the personalized playlist with the previous iteration to determine if any media items occur in both iterations of the playlist. If a media item occurs in both iterations, and was previously represented as a thumb nail in representation of the playlist in the graphical user interface, that media item might not need to be updated when performing an animation (such as illustrated in FIG. 7B, and FIG. 7C) to show that the playlist has been updated.

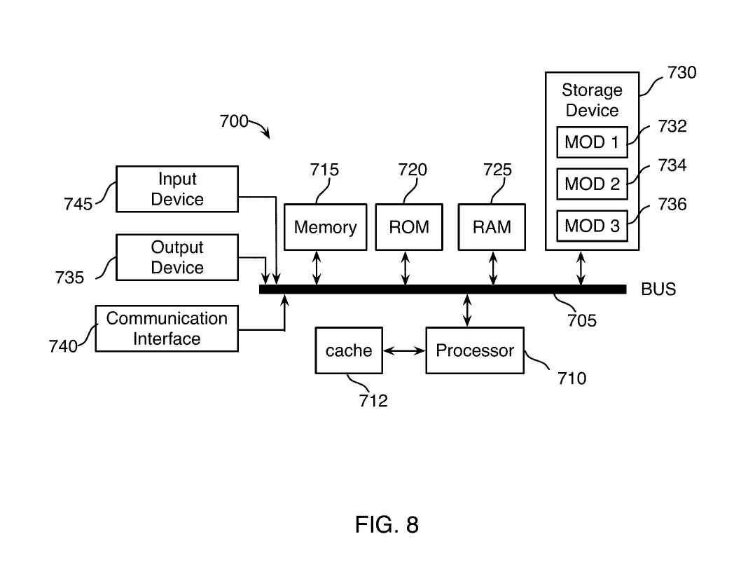

FIG. 8 illustrates a system bus computing system architecture 700 wherein the components of the system are in electrical communication with each other using a bus 705. Any of the computing devices illustrated in FIG. 1 can utilize system architecture 700 or can utilize an alternative architecture such as a chipset architecture. It will be appreciated that one or more components may not be necessary depending on the functions of the computing device.

System 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module (software controlling hardware), such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. While throughout this application software may be described as being performed in convenient to explain steps, these various software modules are not necessarily programmed this way. Some steps might be combined in a single software routine, or object, or application. Some steps might be broken out into many steps, etc.

The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

It can be appreciated that example system 700 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### Modes

In some embodiments there is a non-transitory computer-readable medium comprising instructions stored on the computer-readable medium, the instructions, when executed, are effective to cause the computing device to receive, by a playlist service of a media item playback platform, from a client device associated with an account of the media item playback platform, a request for a refreshed playlist to replace an existing playlist; to determine, by the playlist service, parameters for the refreshed playlist, the parameters including at least a familiarity parameter, and/or an era parameter; to request media item candidates for the refreshed playlist from a personal mix service, the personal mix service identifies media items that are from, or proximate to, a cluster in an embedding space that meets at least one of the familiarity parameter, or the era parameter; to create the refreshed playlist from the candidates; and in response to the request for the refreshed playlist, send the refreshed playlist to the client device.

In some embodiments the instructions to create the playlist include ranking the candidates according to a criterion, and selecting a media item from the candidates for each position in the refreshed playlist based on the ranking of the candidates and a sequencing model.

In some embodiments the embedding space is a collection of media items that are arranged near other media items to which they are deemed similar on the basis that the media items have been identified in collections of user arranged media item sequences found in a population of accounts of the media item playback platform, the embedding space including a plurality of clusters, each cluster including a grouping of media items that are often grouped together in the user arranged media item sequences.

1. A non-transitory computer-readable medium comprising instructions stored on the computer-readable medium, the instructions, when executed, are effective to cause the computing device to:
receive a refreshed personalized playlist, the refreshed personalized playlist being a new playlist created from candidates that have been found to repeatedly appear in user created sequences of media items together, and that conform to media item preferences associated with an account of the media item playback platform;
display thumbnail images of media items in the existing playlist in a graphical user interface; and
after receiving the refreshed personalized playlist, animate thumbnail images of media items in the refreshed personalized playlist replacing media items in the existing playlist.

2. The non-transitory computer-readable medium of claim 1, wherein the instructions are effective to:
receive a push notification by the client device from the media item playback platform notifying the client device that the refreshed personalized playlist is available.

3. The non-transitory computer-readable medium of claim 1, wherein the instructions are effective to:
automatically download and cache the media items in the refreshed personalized playlist on the client device.

4. The non-transitory computer-readable medium of claim 1, wherein the media item candidates that repeatedly appear in user created sequences of media items together were:
generated by a personalized mix service that analyzed collections of media item sequences to identify the media items, the media item sequences being an arrangement of media items grouped together in a user created list, and media items in proximity to each other in a playback history, the collections of media item sequences being from multiple user accounts of a media item playback platform;
embedded into a multi-dimensional abstract embedding space such that media items were located near other media items with which repeatedly appeared in user created sequences of media items together; and
identified clusters of media items in the embedding space that are often grouped together in the media item sequences.

5. The non-transitory computer-readable medium of claim 4, wherein the media item candidates that conform to media item preferences associated with an account of the media item playback platform were generated by a personalized mix service that:
mapped a specific user account from the multiple user accounts of a media item playback platform to the embedding space by locating media items from user created lists associated with the specific user account, and from media items in a playback history associated with the specific user account into the embedding space.

6. The non-transitory computer-readable medium of claim 5, wherein the media items candidates were selected from the embedding space by selecting a cluster within the embedding space including the media items associated with specific user account, and performing a nearest neighbor search on a user specific centroid with the cluster to identify media items that were likely to repeatedly appear in user created sequences of media items together.

7. The non-transitory computer-readable medium of claim 6, wherein the media items associated with specific user account were weighted according to recency of playback, frequency of playback, and inclusion of the media item in the specific user account; the weighting was used to select the cluster within the embedding space.

8. The non-transitory computer-readable medium of claim 6, wherein the personalized replacement playlist was constructed by ranking the candidates according to a criteria, and selecting a media item from the candidates for each position in the refreshed playlist based on the ranking of the candidates and a sequencing model.

9. The non-transitory computer-readable medium of claim 8, wherein the playlist is a music discovery playlist and the criteria includes a preference for media items that haven't been played by the account within a predetermined period.

10. The non-transitory computer-readable medium of claim 1, wherein the playlist is a new music playlist and the criteria includes a requirement that a media item was published in the media item playback service recently.

11. The non-transitory computer-readable medium of claim 2, wherein the instructions are effective to receive multiple versions of the refreshed personalized playlist when the refreshed personalized playlists are made available periodically, and the requesting client device has been offline for at least one complete period, one of the received multiple versions of the refreshed playlist backfills a user interface showing a past refreshed personalized playlist, and one of the received multiple versions of the refreshed playlist is the refreshed playlist for the current period.

12. The non-transitory computer-readable medium of claim 1, wherein the instructions are effective to:
send, to a playlist service of a media item playback platform, from a client device associated with an account of the media item playback platform, a request for a refreshed personalized playlist to replace an existing playlist.

13. A method performed by a computing device comprising:
receiving a refreshed personalized playlist, the refreshed personalized playlist being a new playlist created from candidates that have been found to repeatedly appear in user created sequences of media items together, and that conform to media item preferences associated with an account of the media item playback platform;
displaying thumbnail images of media items in the existing playlist in a graphical user interface; and
after receiving the refreshed personalized playlist, animating thumbnail images of media items in the refreshed personalized playlist replacing media items in the existing playlist.

14. The method performed by a computing device of claim 13 comprising:
receiving a push notification by the client device from the media item playback platform notifying the client device that the refreshed personalized playlist is available.

15. The method performed by a computing device of claim 14 comprising:
automatically downloading and caching the media items in the refreshed personalized playlist on the computing device.

16. The method performed by a computing device of claim 14, wherein the instructions are effective to receive multiple versions of the refreshed personalized playlist when the refreshed personalized playlists are made available periodically, and the requesting client device has been offline for at least one complete period, one of the received multiple versions of the refreshed playlist backfills a user interface showing a past refreshed personalized playlist, and one of the received multiple versions of the refreshed playlist is the refreshed playlist for the current period.

17. The method performed by a computing device of claim 15, wherein downloading and caching the media items includes:
downloading data identifying the refreshed personalized playlist and the media items included in the refreshed personalized playlist; and
determining from the downloaded data which of the media items included in the refreshed personalized playlist are already on the computing device, and then downloading and caching the media items in the refreshed personalized playlist on the computing device.
